(19) United States
(12) Patent Application Publication
(10) Pub. No.: US 2004/0105122 A1
(43) Pub. Date: Jun. 3, 2004

(54) Printer control and document management system

(76) Inventor: Richard J. Schaeffer, Bethel Park, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/725,260

(22) Filed: Dec. 1, 2003

Related U.S. Application Data
(63) Continuation of application No. 09/566,243, filed on May 5, 2000.
(60) Provisional application No. 60/190,856, filed on Mar. 20, 2000.

(51) Int. Cl. G06F 15/00; H04N 1/387; G06K 15/02; G06F 17/30; G06F 7/00

(52) U.S. Cl. 358/1.15; 715/506; 358/1.18; 709/204; 707/104.1

(57) ABSTRACT

A printer control and information management system is provided employing numerous individual satellite modules, and providing an enterprise-wide output system capable of receiving all types of input and redirecting of all types of output. Data can be inputted from any location in an enterprise system and coordinated into a coherent format for reporting and forms processing. Forms can be automatically generated based on the data inputted, which forms can be directed to the appropriate personnel. The system provides for notifications to the appropriate personnel in order to resolve problems which may arise from the operation of the various equipment utilized in the enterprise network system. Information can be redirected to anyone within the system, the user identifying the manner and format of the information to be presented. Thus, inbound reports can be received from different systems and outputs delivered in the format that is preferred by the user. Report recognition is provided for any application, with the ability to merge textual information with electronic forms. Additionally, the forms can be completed with bar code information to prevent inadvertent disclosure of sensitive information. Large and contiguous host generated reports can be electronically distributed to users, as well as the ability to automatically fax any type of report directly to any recipient. The system can be accessed via the Internet for ease of inputting and reviewing information at any location.

### RELATED APPLICATION

This application is related to provisional application Serial No. 60/190,856, filed Mar. 20, 2000.

### BACKGROUND OF THE INVENTION

1. Technical Field

The invention relates to an enterprise output management and information control system, and more particularly to an Internet based forms management and printing program directed to the health care industry.

2. Description of the Prior Art

In large enterprise systems and business ventures, it is not uncommon that numerous personnel require access to various pieces of information regarding a particular project or job, which information is derived from a variety of sources. In the health care industry, for example, a patient can typically undergo a variety of tests performed by numerous and varied health care professionals, ranging from a routine physical exam to more complex procedures such as EKG's, MRI's, and evaluations of clinic tests and lab reports which may be performed as part of a complex medical procedure. In addition, should the patient require surgery or other medical treatment, that information must be accessible by the specialist performing the medical procedure. Additionally, within the hospital environment, various sections of the hospital staff and its administration must have access to that information for payment processing, patient information retrieval, and the like. If the patient occupies a particular room, for example, the nursing station responsible for that patient's room must have access to the patient's chart, whereas those in the billing department must also be notified of any medications or procedures administered to the patient for order tracking and billing purposes. Additionally, the patient's personal physician or specialist treating that patient may also wish to access that information from a remote office or even from their home.

For treatment of the patient, hospital administration, and various health care provider insurance purposes, a variety of forms must also be completed in order to not only treat the patient but also ensure that the hospital and/or health care provider is adequately compensated for their services. Numerous forms must be completed which require only particular information to be filled into that form, whereas certain information such as the name and identification number for the patient are the same on each and every form. This numerous form completion process is very time consuming and involves repetitive information input. Thus, information is not only inputted from various sources, it also needs to be outputted to various locations while the information needs to be properly routed both into and out of the system.

A computer system for such an enterprise is typically large-and complex. A central computing station, such as a network server system, is responsible for coordinating the flow of information both into and out of the system. Every nursing station has at least one computer terminal for inputting patient information as well as for retrieving notifications from the hospital administrators or physicians as to the treatment which is to be administered to the patient. Also, the hospital admitting staff and administrating services also must access and input information regarding the patient's health insurance and which organizations are responsible for processing forms to be completed for bill payment processing, as well as insuring all applicable regulations are complied with. Additionally, physicians may need to access the information from their offices over a global telecommunications network, such as the Internet, for retrieving information about a particular patient, as well as inputting information regarding treatment that has been provided to the patient. Numerous databases are also provided such that patient medical history can be accessed by the physician or other health care provider so that information like allergies and prior family medical history can be accessed and immediately reviewed by the health care provider to ensure that the best possible care is provided to that particular patient.

As many areas within the hospital have access to the computer system via a desktop personal computer (PC), numerous peripheral equipment is connected to the computer system, such as printers, fax machines, or even the telephone system. Patient charts, for example, may be printed at each nursing station in addition to the forms that need to be printed by the hospital administrative staff. Additionally, members of the hospital staff may be notified of incoming phone messages or e-mails that must be attended to. Patient reports and test results may also be needed on an immediate basis at various locations within the health care facility. For example, in the event for an emergency where a patient must be moved from his or her room for an emergency operation, the operating room staff needs immediate access to patient care information as well as print-outs and reports of the condition affecting that patient. Thus, it is very important that the operation of these peripheral devices be maintained and that appropriate personnel be notified in the event of an error. For example, a printer malfunction must be brought to the attention of the personnel in the immediate area for routine maintenance items such as a paper jam or that the machine needs to be refilled with blank paper. More complicated service requirements such as a printer malfunction or a system malfunction must be brought to the attention of the information systems personnel so that they can be corrected as soon as possible in order to ensure the proper flow of information through the facility.

Since many people have access to the computer system at any one time, it is not uncommon for more than one print job to be queued or requested at a particular printer from various locations within the health care facility. Proper queuing of these jobs within the system's print queue is required in order to ensure the smooth flow of information throughout the facility. Since these computer systems are highly complex and require numerous PC's and peripherals to be interconnected, it is very common for components to be supplied by more than one original equipment manufacturer (OEM) which must then be integrated within the system. For example, computers can be manufactured by a number of OEMs, such as Dell, Compaq, Hewlett Packard, IBM, etc. Printers may be manufactured also by Hewlett Packard, IBM, LexMark, or any other of the various printer manufacturers. Also, photocopier machines can also be integrated within the system to act both as a photocopier and as a report printing peripheral which can also have a variety of manufacturers. The operating system for this enterprise may be Windows based or Unix depending on the type of system desired by the information systems personnel. The operating system must be able to coordinate with each of the different peripheral components using each of their varied communication protocols in order to ensure that all the information is processed correctly and expeditiously.

What is needed then is a system whereby information flow through a large enterprise, such as a health care facility, can be facilitated in an expeditious manner. The system should enable the correct routing of information, accurate form processing, as well as facilitating, operation and maintenance of peripheral equipment.

It is therefore an object of the present invention to provide a-system for the manipulation and transfer of information and data in a system wide enterprise.

It is another object of the present invention to provide a computerized system for the processing of forms in a health care facility.

It is a further object of the present invention to provide a system for notifying appropriate individuals of the operational efficiency of equipment within the enterprise facility.

It is a still further object of the present invention to provide a computerized office system for the routing and queuing of print jobs within a complex computer network.

### DISCLOSURE OF THE INVENTION

An enterprise output management and information control system is provided for managing data transmissions between pluralities of workstations and application servers and digital output destinations. The management and control system includes a system server in communication with each of the pluralities of workstations and application servers and digital output destinations. The system server receives report jobs generated at the plurality of workstations and application servers, translates the received report jobs into a format appropriate for a destined digital output destination, and routes the received report jobs in the appropriate format to the destined digital output destination.

In one form, the system server includes pluralities of input and output ports and queues, respectively, and a rules and analysis system. The plurality of input ports receives the generated report jobs from a plurality of workstations and application servers. The plurality of output queues are each assigned a particular digital output destination to which report jobs are submitted. The rules and analysis system analyzes the report jobs received at the plurality of input ports, translates the analyzed report jobs into a format appropriate for a destined digital output destination, and routes the translated report jobs to the output queue associated with the destined digital output destination.

In another form, each of the plurality of input ports is assigned a particular data format and a particular input transport mechanism for receiving the generated report jobs. The various data formats may include PJL, PCL, Test and Raw SNA/APPC data formats. The input transport mechanisms may include file transfer protocol (IP/FTP), Net BIOS/Net BEUI printer shares, file sharing systems as established by network operating system manufacturers, line printer requester/line printer daemon relationships (LPR/LPD), and Internet printing protocol.

In still another form, the plurality of output queues each includes a transmission mechanism for examining and evaluating a status of the plurality of digital output destinations. The transmission mechanism may include SNMP Query and Response, IP Ping and Response, Accessibility of Network File Share, and existence and content of a status file.

In yet another form, the plurality of output queues generates an alert notification upon detection of an abnormal condition at its assigned digital output destination and communicates the alert notification to select alert recipients via an alert mechanism.

In a further form, the generated report jobs are in the form of report data, with the system server further including a forms database storing a plurality of different types of forms, and a report formatting module which analyzes the report data, selects one of the plurality of forms from the forms database based upon the analyzation, and merges the report data with the selected form to develop the received report jobs.

Data can thus be input from any location in the management and control system and coordinated into a coherent format for reporting and forms processing. Based upon analyzation of the input data, forms are automatically generated and directed to appropriate personnel. To prevent the inadvertent disclosure of sensitive information, the forms may be encoded with bar code information. Alert mechanisms are utilized to notify appropriate personnel of problems arising from operation of the equipment. The management and control system may be accessed by a user at a remote location, thus enabling the input and review of information at virtually any location.

### BRIEF DESCRIPTION OF THE DRAWINGS

FIG. 1 illustrates the overall system architecture for an information management and control system according to the present invention;

FIG. 2 is a diagram illustrating the flow of a print job through the information management and control system of the present invention;

FIG. 3 is a flowchart illustrating the detection and notification of error events by the system of the present invention;

FIG. 4 is a typical Window screen for the notification of a print queue problem in the inventive system;

FIG. 5 is a typical Window screen for the notification of an SRM problem in the inventive system;

FIG. 6A illustrates a typical Microsoft NT spooler;

FIG. 6B illustrates a spooler for use in the inventive system;

FIG. 7 illustrates a form for use with the inventive system; and

FIG. 8 shows a graphical user interface depicting the support of numerous print queues by servers in the inventive system.

### DESCRIPTION OF PREFERRED EMBODIMENTS

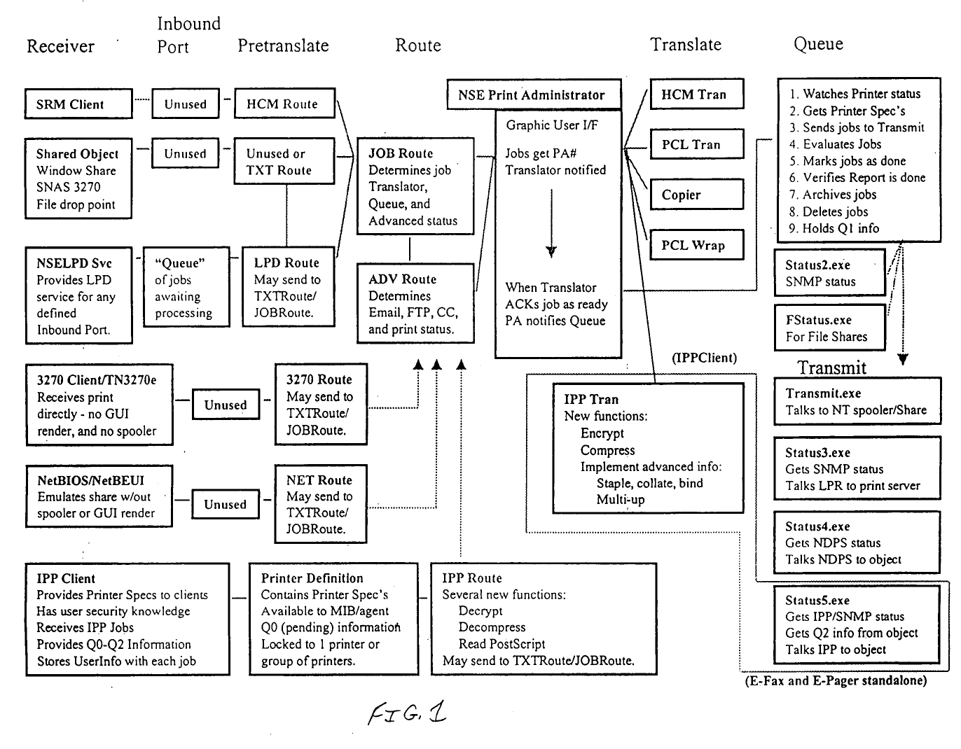

Referring now to the drawings in detail, there is shown therein an enterprise-wide information management and document processing system according to the present invention. FIG. 1 shows an overall system architecture for the information management system of the present invention. With the document and information management system of the present invention, the appropriate personnel can be notified of equipment malfunctions, routing and queuing of print jobs are more efficiently performed, forms can be automatically completed based on the information provided, electronic faxing can be accomplished directly from a personal computer (PC), as well as delivering reports to the appropriate person within the organizational structure. The present invention is particularly directed to the efficient operation of a health care facility.

In its most preferred embodiment, the present invention is designed to work with an operating system configured for Microsoft NT 4.0 and enterprise hardware and enterprise server software. Accordingly, the preferred embodiment of the present invention operates with the hardware and software set forth in the accompanying Table 1. However, it will be appreciated by those skilled in the art that other hardware and software components can be added or modified accordingly.

In order to ensure the correct routing of information within the system, it is desired to establish certain printer definition and rules according to the present invention. In this manner a compartmentalized printer model segregates inbound data from outbound data in order to route the information to the particular printer at which a report, for example, is to be printed.

The standard definition of a printer object provides a singular object for both the receipt and transmission of a print job. In addition, printer servers receive data from clients, which may be other computers, user work stations or other processes that generate print data. In turn, print servers send data to physical print devices, which refer to either a network attached printer, a print sharer, a file sharer or some other recipient's service such as a fax machine. Inbound data is information sent from a different computer or different process on the same computer system. Outbound data is information that is be sent to a different computer or process. All of the inbound or outbound data necessary to print a report is called collectively a print job. Print jobs can contain many unique characteristics, including origin, user naming and content. These qualities can be categorized to give the report a report name. Inbound and outbound data may contain various types and classes of printer specific control codes. The types of codes used are called the print job format, examples of which include print job language (PJL), printer control language (PCL), ASCII/text format, or other proprietary format. Information flows via a transport mechanism, which allows data to be sent between two entities such as a client computer to a server computer or a client process to a server process. Examples of transport mechanisms for print data include: file transfer protocol (IP/FTP); Net BIOS/Net BEUI printer shares; file sharing systems as established by network operating system manufacturers; line printer requestor/line printer daemon relationships (LPR/LPD); and Internet printing protocol.

In segregating inbound data from outbound data, the document management system and report queuing system of the present invention segregates the functions of a print object as distinct defined entities. For example, each port is given a unique name which may be referenced by the rules and analysis system discussed below. The ports provide basic information about the target printer to the user and act as receiving locations for inbound data. The data may be arranged in any prearranged format: PJL, PCL, Test, Raw SNA/APPC data, etc. Preferably each port is limited to one particular data format and one transport mechanism. Additionally, each port can have separate and unique security access, as well as user restrictions or inclusions. Each port maintains is own queue of unprocessed jobs and its own history of received jobs. Ports may receive data intended for one or more destination queues.

Preferably one queue definition is provided for each physical print device. Each queue is given a unique name which must be referenced by the rules of the system. Each queue acts as an independent entity receiving jobs directly or indirectly from inbound ports and submits them individually to a physical print device. Queues have a variety of transmission mechanisms at their disposal, but have one such mechanism defined. Queues also have the ability to examine and evaluate the status of a physical print device, and the status of a device can be used to start and stop the flow of reports. The status of the print device can be derived using a variety of mechanisms, including, but not limited to: SNMP Query and Response, IP Ping and Response, Accessibility of Network File Share and existence and content of a particular file. Queues may receive data from one or more inbound ports.

The rules and analysis system is used to determine the direct outbound queue for each job received on an inbound port. In the segmented printer object definition, a rule system is used to manage and control the flow of reports. Since there is a separation between inbound ports and outbound queues, there is the opportunity to create many routing situations. According to the system of the present invention, jobs are analyzed for content and assigned two names. One name relates to the point of origin of the report (origin name), and the other name relates to the specific content of the report (report name). Jobs can be translated from various inbound formats to the format appropriate for the outbound queue. Copies of the jobs can be made for archival and management purposes, and can be made from more than one queue allowing “carbon copy” style functions. For example, several types of rules defined in the system include:

Default destination—if a job arrives at inbound port A and no other rules apply, the job is preferably sent to outbound queue B.

Content based naming—if a job arrives at inbound port A and it contains the word “evaluation” on page 1, line 3, column 21 of the report, the job is named “patient evaluation”.

Content based translation—if a job arrives at inbound port A and has been named “patient evaluation”, it is preferably translated by PCL translator before being sent to an outbound queue.

Content based designation—if a job arrives at in inbound port A and has been named “patient evaluation”, it is preferably sent to outbound queue C.

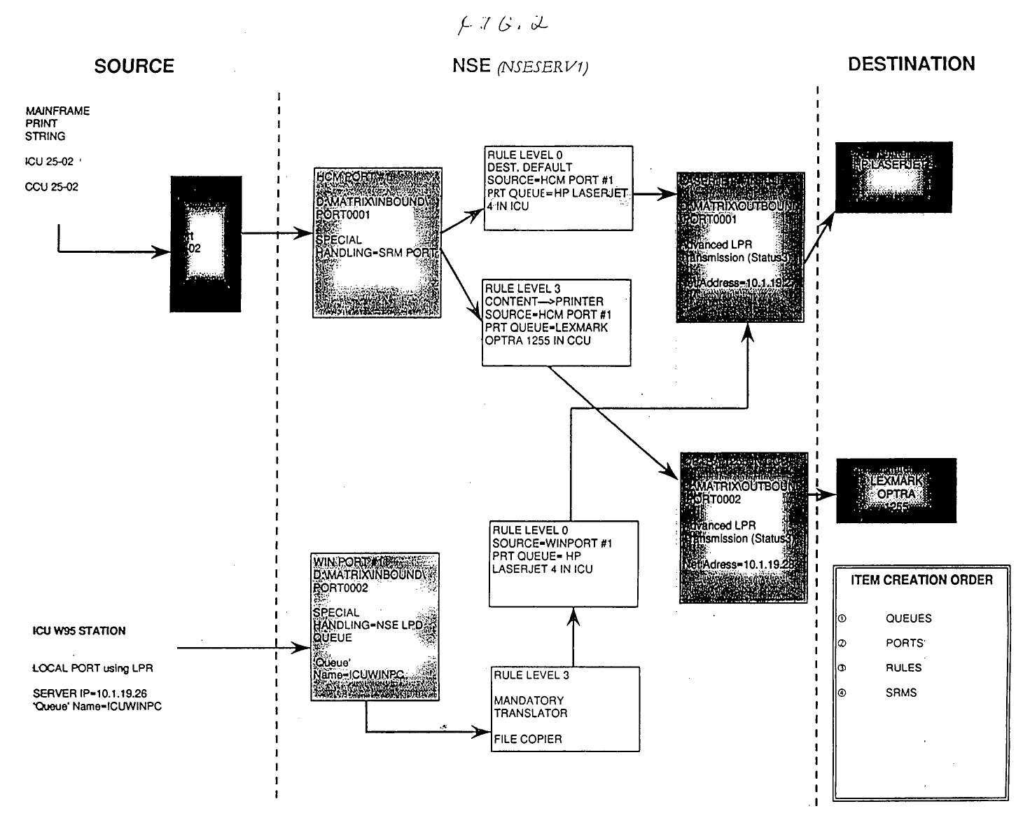

Shown in FIG. 2 is a diagram of the flow of a print job through the system of the present invention. A print job is identified at the source and is routed through the server of the present invention to the desired printer destination. There are two types of printjobs shown therein, the upper one being a mainframe print string for printing at the intensive care unit (ICU) and the cardiac care unit (CCU). The lower print job is for printing of a document at the ICU station. The mainframe print stream is sent through an SRM and is sent through the HCM port #1 and distributed to two different rule levels, rule level 0 as a destination default printer and rule level 3 as a content printer. SRM refers to an SNA/APPC server between the server and the host application on the mainframe, explicitly for the purpose of downloading report data into the server. The first rule level 0 is sent to the desired print queue, such as an HP LaserJet 4 in the intensive care unit and the other is sent to the print queue for a LexMark Optra 1255 in the cardiac care unit. The outbound data is then queued in the LaserJet printer in the ICU and also to the print queue for the CCU. Thus, the same document can be simultaneously prepared for two different destinations within the health care facility.

It should be understood that routing a print job to a desired printer destination is only one of the many capabilities of the inventive system. The inventive system may manage and control the routing of any type of report job to any type of digital output destination, which may be any type of electronic device or media that is capable of receiving, rendering or storing report information, such as, but not limited to, lasers, fax machines, pagers, personal digital assistants (PDAs), disk files, optical media, voice systems, web pages, e-mail systems, ftp sites, etc.

Referring back to FIG. 2, for the lower report using a local port using Line Printer Requestor (LPR), the inbound data is sent to winport #1 and governed by rule level 3 which requires a mandatory translator and file copier. It is also sent through rule level 0 and the desired print queue. As before, this document is sent through the print queue into the particular printer equipment used in the ICU, in this example the HP LaserJet 4.

As part of the peripheral management module of the present invention, notifications are provided when a printer needs servicing. This can be as minor as a paper jam or a printer or other peripheral device needing paper, or more complicated situations such that a service technician needs to review or needs to perform service on the machine. Preferably, an escalating alert notification model is provided. On an alert event basis, the system is configured such that more urgent alerts are provided when more complex problems are discovered. Within the printer control and document management system of the present invention certain events may occur that go unnoticed and the notification system exists to call attention to these events. An alert event is defined as some abnormal condition that exists within the various peripheral components involved in the secure end-to-end delivery of information within the health care facility complex. An alert notification is the information used to describe that abnormal event. A notification mechanism is used to communicate to the recipient of the alert modification. A notification event is defined as the transmission of the alert notification and alert mechanism. The variable amount of lapse time between notification events during an unresolved alert event is an alert interval, and an alert schedule is the number of alert intervals defined for a particular event for each component involved in the system. According to the present invention, notification escalation is used as a process of scheduling each notification event at the appropriate intervals when an alert event remains unsolved.

On an alert event basis, the system can be configured for the alert schedule and alert intervals, each using an independent notification mechanism. Upon execution of each alert interval, one or more alert recipients can be designated through the use of one or more notification mechanisms. Alert mechanisms include, but are not limited to, network message, e-mail, visual on-screen alert, auditory alert, pager, computerized voice mail call directly to the recipient's telephone, a local application launch, a remote application launch or an error log entry. By using variable criteria for an alert event, variable notification mechanisms, variable number of alert intervals, a variable alert schedule, and variable number of alert recipients, the probability of rapid alert event resolution is maximized. A flowchart showing these mechanisms is shown in FIG. 3.

For example, using the mainframe printstring (spooler) for a print job to the ICU and CCU which has been delivered to the SRM #1, an SRM and/or queue identity problem is sensed and a notification issued, as shown by the decision diamond. Depending on the type of problem identified, either network messaging, application launch, computerized voice mail, or an auditory alert is provided. In the case of an e-mail notification, the server is notified to provide such an indication to the appropriate recipient at the e-mail notification port. In the case of pager messaging, the notification paging inbound port also receives a message. In the meantime, the HCM port #1 continues to send the message to the HP LaserJet 4 printer and the LexMark Optra 1255 printer in order to attempt to print the report at the appropriate locations. The notification paging inbound port and the e-mail notification port also send messages through the rule process to the appropriate pager and the e-mail recipients. These messages are sent to the e-mail output queue and the paging system output queue, and appropriate messages are sent through the paging system and the e-mail system. In the event, for example, that the identified problem is merely that one of the printers is out of paper, the print job remains in the queue until such time as additional paper is added to the machine, thus preventing loss of the print job while this routine maintenance is performed. In any event, upon resolution of the problem, the job remains in the appropriate print queue to prevent loss of data transfer.

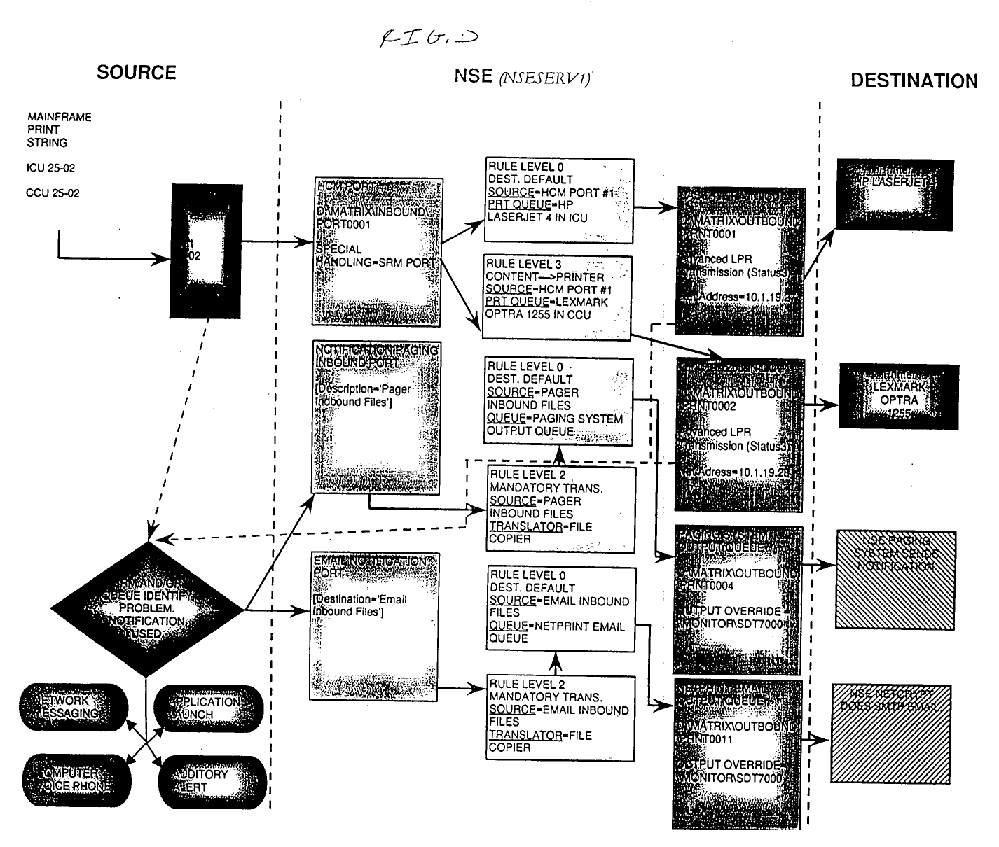

As shown in FIG. 4 for example, the notification system allows administrators to alert certain individuals or groups of people that there is a potential problem with a particular device, or problems with one of the components of the system. Notification is available for print queues, SRMs, monitors, PA disk notification or failover from the monitor work station. Each feature has the same configuration window as shown in FIG. 4: The types of messages that are available depend on the module that is being configured. For example, print queue notification has the capability to alert a user that the printer is “off-line”. This application, for example, would not be applicable to the PA disk notification since this feature is particular to the server disk space. The typical Window screen shown in FIG. 4 is a notification for a print queue problem. While the notification screen maybe the same for an SRM notification, for example, the message choices sent to the user are different depending on the alert condition.

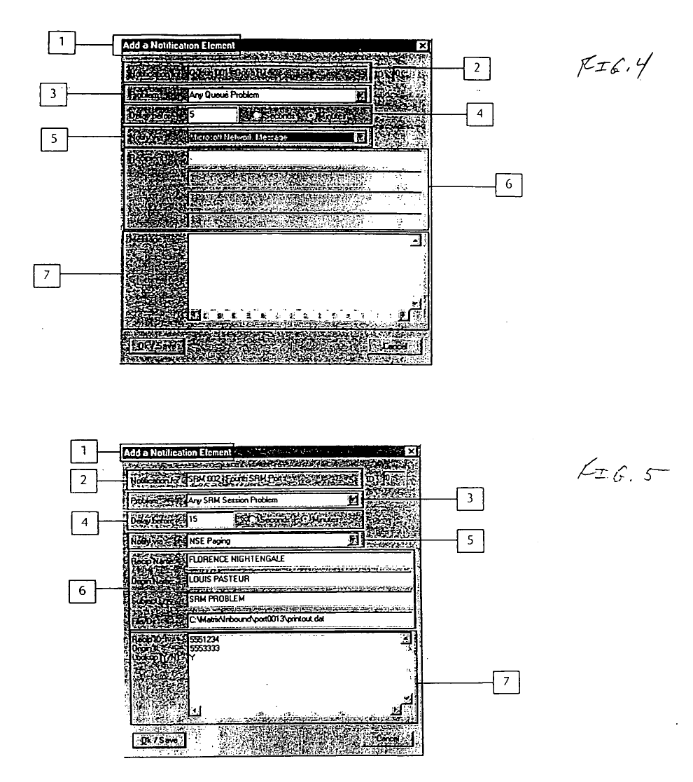

The notification alert window has seven basic elements. In the title bar, box 1, the user is informed that the window is active, in this case a notification element. The notification is provided in box 2 and describes what the notification is for. In this example, it is for a queue and that queue is for a printer. The problem is identified in box 3, which is a drop list of predetermined problems. These problems can occur with any queue. Preferably this list cannot be edited as the system is configured to identify certain common problems typical of printers and other equipment. In box 4, the notification program is configured in either seconds or minutes as to-how long the system should wait before sending out a notification to a user, or a group of users, that a problem has occurred. This prevents spurious alert notifications in the event that it is a condition that can be readily corrected by the peripheral device diagnostic system. Box 5 indicates how the notification message will be sent. There are numerous ways that the system can perform this alert notification, and again a drop down menu is provided. In the instance shown, a network message is sent through the Microsoft operating system to the group of users previously identified to receive such an alert notification. Recipient information is provided is box 6 and changes depending on the methodology used to notify a person of a problem. The message in box 7 also is changed depending on the methodology used to notify a person of problem. This can been seen by comparing FIG. 5 with FIG. 4, FIG. 5 being an SRM notification window.

In the case of an SRM notification, for example, notification in this instance has been chosen as the paging system. In comparing FIG. 5 with FIG. 4, it is noticed too that the recipient identification has more information attached in each of the labels in box 6. These labels instruct the user what type of information is to be keyed for the recipient. Also, the recipient I.D. in box 7 has information therein to show that it is no longer just a message box but a box requiring information concerning the pager of the person receiving the alert notification.

In a preferred embodiment, the notification system supports fifty (50) layers of escalation. For example, when a printer power out is detected and goes unresolved for a period of fifteen minutes, for example, the user receives a Windows message on their computer screen. If the printer continues to be powered out for a period of fifteen minutes, the systems administrator receives a message and if the problem continues for thirty minutes, the duty officer receives an alpha numeric pager message, and so on. While most problems are easily resolved by-the end user; establishing who the appropriate end user is at any given time may be difficult. To resolve this issue, the voice notification system can be used. In the notification escalation module, the phone number that is in the vicinity of the printer can be stored. At a given interval, the information management system of the present invention can automatically call the appropriate phone number and play a recorded message asking the person who answers that phone to examine the printer. Thus, the person in closest proximity to the peripheral device can be notified and requested to inspect the device for proper operation. In this way, the problem is brought to someone's attention promptly. A different message can be used at given intervals to indicate the level of urgency in resolving problems. By use of the paging system in addition to the voice mail message, a person in close proximity to the device can always be notified, since the pager is mobile with a person carrying that pager, who may be at a location far removed from the peripheral device for prompt attention. Moreover, the burden on support personnel to handle routine maintenance matters, such as empty paper trays, frees up the systems administrative personnel for more complex problem solving.

A systems archive viewer is also provided to allow users to view reports that have been received at the system server. Essentially the server acts as a permanent spooler thus reducing the reliance on host systems to retain reports. The archive viewer preferably renders reports according to their intended designation. For example, if the report was sent to a laser printer, then the viewer would render the PCL format so that it would display the page on the screen just as it would appear on paper. This allows configurable archiving and retention of reports which are also accessible by a web browser with access to the server. Reports can be easily reprinted since they are stored on the server or, optionally, a person can view the report at any time without having to print out the report each time, thus saving on paper and printer toner expenses.

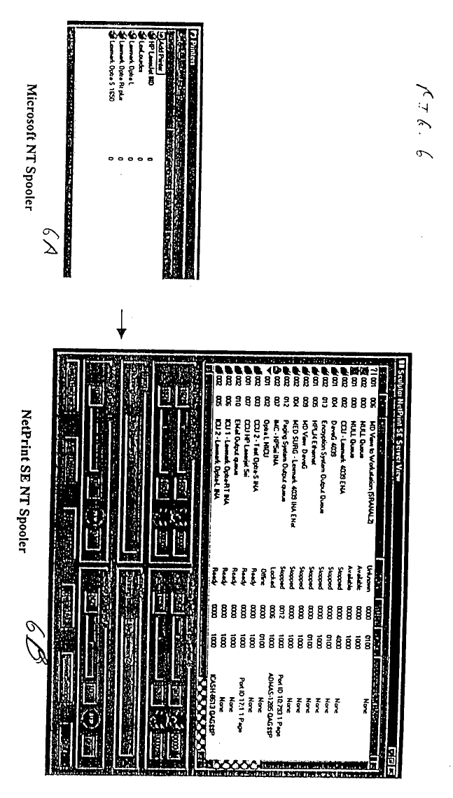

While the document and information management system of the present invention is built to be compatible with the Microsoft NT operating system, the present invention replaces the print spooler as a conduit for job transmission to the printer. This is shown in FIG. 6, in which the typical Microsoft NT spooler is shown in FIG. 6A and the spooler of the present invention is shown in FIG. 6B. The spooler of the present invention presents problems which typically occur due to conflicts within the Microsoft NT spooler. For example, when a print object misfires during transmission, the entire Microsoft NT print spooler must be stopped and restarted. The spooler of the present invention, however, employs its own LPD service and its own transmitters. Thus, any transmitter problem can be taken care of without impacting the entire spooler. Thus, the print spooler of the present invention provides a multi-threaded fault tolerant solution. In this way, print queues experience fewer problems and reports flow more reliably. There is no longer a need to stop and restart the entire spooler service. Thus, support calls are decreased due to lower incident of spooler trouble and the spooler and transmission services are now accessible to developers at a code level.

The present invention also comprises a micropositional report formatting module. While many current document management systems house information in fields in a database, it is a common requirement to print this data directly on these forms. An alternative is to merge the data with an electronically stored form prior to printing. This also requires that the forms be saved on a person's harddrive, for example, so that a person at that PC can access that form and supply the information necessary in the appropriate spaces. Frequently, the part of the document management system that includes the data is not designed to properly format that data for the intended form. Thus, it is difficult to manipulate the data so that it is applied in the appropriate spaces in the form. With the approach of the present invention, reports are identified as they are received and compared to a database of known reports. The report data can be modified so that it is placed precisely on the electronic or preprinted form, even if the form does not utilize standard pitch or character spacing. The formatting is accomplished without extraction of the data fields or any knowledge of form fields at all. Rather, the horizontal and vertical coordinate systems for the characters on the page are manipulated. Definition of this alteration for any specific combination of data and electronic form is stored in a configuration file. The vertical and horizontal coordinates can be moved up, down, left or right. Additionally, the position of any individual line of data can be explicitly defined. In this way, it is not necessary to store numerous electronic forms in database format, which forms need to be accessed individually and the information placed directly therein. Rather, the form is automatically created from the type of report that is being prepared by the user. Thus, the inventory of forms that are required in a health care facility, for example, can be eliminated by this horizontal and vertical coordinate system of the present invention. Moreover, the person completing the form need not know exactly what form is to be processed but rather need only to start inputting the data and the correct form is automatically created.

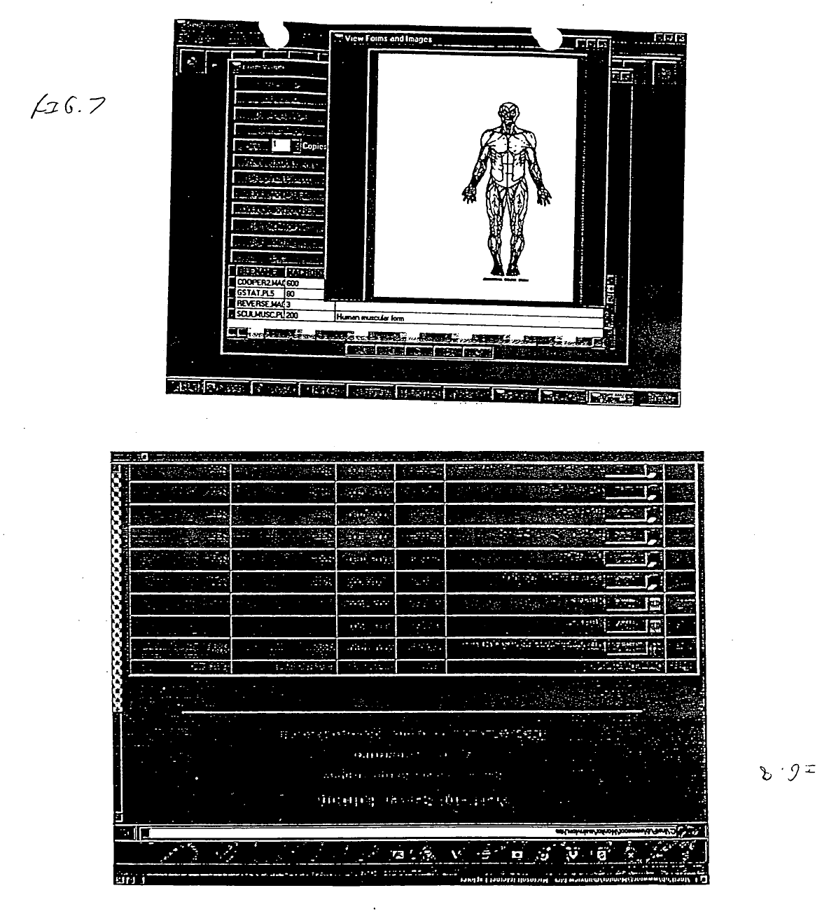

In a companion module, the form vision module of the present invention manages the health care institution electronic forms database. These forms can be stored centrally on the server to be accessible across the entire institution. As reports are processed, the document management system of the present invention taps into the form vision module to download the electronic form to the printer and merge any textual report data with the form. Moreover the information systems personnel can use this module to create links between reports and electronic forms. End users utilize the forms module to print copies of electronic forms on demand. A depiction of a typical form is shown in FIG. 7. Since the forms are stored in a centralized area, such as the server, they can be directed to print on any printer which is attached to the network. Also, forms can be easily electronically merged with report data as in the micropostional adjustment system. An end user can print any electronic form on demand through the browser enabled interface from any PC that the user may be utilizing.

With the document and information management system of the present invention, it is possible to fax an electronic page from the system directly to a fax machine. A virtual electronic page model is used for fax rasterization. Since faxing is the process of rasterizing or bitmapping the content of a document and transmitting it across phone lines to a facsimile device which renders the raster transmission on paper or a screen, the system can use the electronic documents created to automatically send those documents to a fax machine without having to preprint the document. In prior art document management systems, document materials must be scanned and rendered as a bitmap prior to fax transmission. While document material can be sent directly from a PC application, it is difficult, if not impossible, to combine two or more documents that exist independently of each other prior to such a fax transmission. With the system of the present invention, document data from a first source can be merged with document data from a second source thus creating a virtual electronic page to be faxed to another machine. Additionally, information from a first page can be merged with information from a second page without having to re-enter the data into a single document. Thus, the information from two or more documents are blended on the electronic virtual page before being placed into the fax format. The result is a single electronic page that is either a single complete document or appears to have two or more document images superimposed on top of each other. Thus, the data is merged with a “blank” electronic form to present a single document, whereas that single document presently does not actually exist. This eliminates the need to have to fill out paper forms which then must be refaxed on a stand-alone fax machine.

Therefore, the present invention facilitates the speedy delivery of information from one facility to another, such as from a hospital to a doctors office, or vice-versa. Additionally, the information from various areas within a hospital, such as patient information from a nurses station, diagnosis information from a doctors office, clinical and lab results, and the like can be merged into the single document for transmission to the person needing that complete information. Usually, this raw data is generated in totally different computer application programs. The system of the present invention can take this raw data and automatically place it into the correct form and send it to the appropriate care giver thus eliminating several steps in the form report processing. Another method of printing out documents is with an Internet printing protocol (IPP). This system allows any browser-enabled PC to print and receive print jobs across the Internet. The system of the present invention utilizing IPP allows the reception and/or transmission according to the IPP standard. The modules of the present invention can work along with this protocol to prevent pages being lost as they are transmitted across the Internet. Since IPP allows the use of built-in compression reducing bandwidth, more documents can be sent over a shorter period of time. Also, printer management can be maintained through any PC connected to the Internet, thus the support personnel can be in any location and can access all of the modules and display screens necessary to analyze any problem. Moreover, it is also possible to print directly to another persons browser, thus eliminating the need to provide paper documents, such as by express mail or fax. Also, compatible e-mail systems are not necessary between the sender and receiver for receiving document attachments.

Occasionally, for security and confidentiality reasons, it is desirable to bar code the information provided on a form. Many current systems do not have the ability to provide analog information into such a digital format on a printed form. Upon unattended report identification, the system of the present invention can automatically establish the information to be bar coded. This identification can be accomplished by predefined row and column locations, a predefined prefix string or a predefined fixed sequence. The bar code can then be rendered on the page in either landscape or portrait orientation. Additionally, this allows certain information, such as medications that have been provided to the patient, to be bar coded directly on the form so that the appropriate personnel can scan the bar code and use such information for inventory purposes, for example. Also, sensitive information such as the patient's medical condition can be placed in bar code form so that a casual observer or person who may happen to be passing by a printer where the document is being printed cannot view such sensitive information, thereby preserving patient confidentiality. This also adds a level of encryption to documents being transmitted over the Internet.

In the document management system of the present invention, the system is preferably deployed in server pairs. Each server supports numerous print queues as shown in FIG. 8. While it is the responsibility of the facility information systems (IS) personnel to monitor the system and respond to issues, the browser-enabled server view of the present invention allows IS personnel to view a single station that shows a combined display of the queues on both servers. The graphical user interface shown in FIG. 8 preferably uses color coded icons to depict queue status. Preferably, problem queues sort to the top of the display so that they are easily seen even from a distance. This allows the IS personnel to access that information from any PC with a web browser and to address problems even when they are not in the vicinity of the server. Thus, this allows support access from a remote location, such as across a university campus, in corporate settings, or any enterprise wide activity where people are located in not only more than one building but in more than one city. By use of the Internet browser-enabled server view, no client software needs to be installed at any particular PC and thus eliminates the need for client upgrades since new features are enabled on the web server. Password protection and privileges are enabled on a queue basis allowing flexible access so that report traffic can be managed via the queue with redirection, locking and other similar means.

There has been described herein a printer control and information management program enabling the input and output of data in an enterprise-wide manner, in particular with respect to a health care facility. It will be recognized by those skilled in the art that this invention is applicable to any such system, such as, but not limited to, a large corporate setting having offices in different cities, in order to manage reporting and documentation. For example, in a large project, individuals from different disciplines within the corporation, such as engineering, marketing and purchasing, can coordinate without having to be physically located in the same location. The information management system of the present invention allows the users to input their data into the central location, which information can be then automatically directed into the proper format into the appropriate users. For example, engineering personnel, while deciding what specifications a particular product must be designed to meet, can access information that the purchasing department has provided from contacting suppliers and specific information based on the specifications provided by the engineers can automatically be sent to the engineering personnel in the specified format. This information can also be delivered in a variety of ways, such as by faxing directly to the person's PC, or by automatically generating an e-mail to the recipient. Thus, while specific embodiments of the invention have been described in detail, it will be appreciated by those skilled in the art that various modifications and alterations could be developed in light of the overall teachings of the disclosure without departing from the spirit and scope thereof. Accordingly, the particular arrangements disclosed are meant to be illustrative only and not limiting as to the scope of the invention, which is to be given the full breadth of the appending claims and any and all equivalents thereof.

What is claimed is:

1. An enterprise output management and information control system for managing data transmissions between pluralities of work stations and application servers and digital output destinations, said system comprising:
a system server in communication with each of the pluralities of work stations and application servers and digital output destinations, the system server (a) receiving report jobs generated at the plurality of work stations and application servers, (b) translating the received report jobs into a format appropriate for a destine digital output destination, and (c) routing the received report jobs in the appropriate format to the destined digital output destination.

2. The enterprise output management and information control system of claim 1, wherein the system server comprises:
a plurality of input ports receiving the generated report jobs from the plurality of work stations and application servers;
a plurality of output queues each assigned a particular digital output destination to which report jobs are submitted; and
a rules and analysis system (a) analyzing report jobs received at the plurality of input ports, (b) translating the analyzed report jobs into a format appropriate for a destined digital output destination, and (c) routing the translated report jobs to the output queue associated with the destined digital output destination.

3. The enterprise output management and information control system of claim 2, wherein each report job is generated in one of a plurality of data formats and transmitted from the plurality of work stations and application servers to the system server via one of a plurality of input transport mechanisms, and wherein each of the plurality of input ports is assigned a particular data format and a particular input transport mechanism for receiving generated report jobs.

4. The enterprise output management and information control system of claim 3, wherein the plurality of data formats comprise PJL, PCL, Test and Raw SNA/APPC data formats.

5. The enterprise output management and information control system of claim 3, wherein the plurality of input transport mechanisms comprise file transfer protocol (IP/FTP), Net BIOS/Net BEUI printer shares, file sharing systems as established by network operating system manufacturers, line printer requestor/line printer daemon relationships (LPR/LPD), and Internet printing protocol.

6. The enterprise output management and information control system of claim 2, wherein the plurality of input ports each maintains its own queue of unprocessed report jobs and a history of received report jobs.

7. The enterprise output management and information control system of claim 2, wherein the plurality of output queues each include a transmission mechanism for examining and evaluating a status of the plurality of digital output destinations.

8. The enterprise output management and information control system of claim 7, wherein the transmission mechanism is selected from the group consisting of SNMP Query and Response, IP Ping and Response, Accessibility of Network File Share, and existence and content of a status file.

9. The enterprise output management and information control system of claim 7, wherein the plurality of output queues generate an alert notification upon detection of an abnormal condition at its assigned digital output destination.

10. The enterprise output management and information control system of claim 9, wherein the alert notification is communicated to select alert recipients via an alert mechanism.

11. The enterprise output management and information control system of claim 10, wherein the alert mechanism is selected from the group consisting of a network message, e-mail, visual on-screen alert, auditory alert, pager, voice mail, local application launch, remote application launch, and an error log entry.

12. The enterprise output management and information control system of claim 1, further comprising an archive viewer storing all report jobs received at the system server.

13. The enterprise output management and information control system of claim 12, wherein report jobs stored in the archive viewer are stored in the appropriate format of their destined digital output destination.

14. The enterprise output management and information control system of claim 1, wherein the generated report jobs include report data, and wherein the system server further comprises:
a forms database storing a plurality of different types of forms; and
a report formatting module (a) analyzing the report data, (b) selecting one of the plurality of forms from the forms database based upon the analyzation, and (c) merging the report data with the selected form to develop the received report jobs.

15. The enterprise output management and information control system of claim 14, wherein the report data includes a first horizontal and vertical coordinate system and the selected form includes a second horizontal and vertical coordinate system, and wherein the system server further comprises a configuration file storing alteration information data indicative of merging report data having the first horizontal and vertical coordinate system with the form having the second horizontal and vertical coordinate system, the alteration information data accessed and used by the report formatting module in merging the report data with the selected form.

16. An enterprise output management and information control system for managing report data generated at a work station and/or application server, said system comprising:
a forms database storing a plurality of different forms each having a unique format of horizontal and vertical coordinate data, wherein the generated report data has a unique format of horizontal and vertical coordinate data selected from a plurality of horizontal and vertical coordinate report data:
a configuration file storing a plurality of alteration configuration data files, one for each combination of report data and file formats;
a report formatting module (a) analyzing the generated report data, (b) selecting one of the plurality of different forms from the forms database based upon the analyzation, (c) selecting one of the plurality of alteration configuration files based upon the unique formats of the generated report data and selected form, and (d) merging the generated report data with the selected form using the selected alteration configuration file to develop a final form document.

17. A document and information control system for managing data transmissions between pluralities of work stations and print devices, said system comprising:
a system server in communication with each of the pluralities of work stations and print devices, the system server (a) receiving print jobs generated at the plurality of work stations, (b) translating the received print jobs into a format appropriate for a destined print device, and (c) routing the received print jobs in the appropriate format to the destined print device.

18. The document and information control system of claim 17, wherein the system server comprises:
a plurality of input ports receiving the generated print jobs from the plurality of work stations;
a plurality of output queues each assigned a particular print device to which print jobs are submitted; and
a rules and analysis system (a) analyzing print jobs received at the plurality of input ports, (b) translating the analyzed print jobs into a format appropriate for a destined print device, and (c) routing the translated print jobs to the output queue associated with the destined print device.

19. The document and information control system of claim 18, wherein each print job is generated in one of a plurality of data formats and transmitted from the plurality of work stations to the system server via one of a plurality of input transport mechanisms, and wherein each of the plurality of input ports is assigned a particular input data format and a particular transport mechanism for receiving generated print jobs.

20. The document and information control system of claim 19, wherein the plurality of data formats comprise PJL, PCL, Test and Raw SNA/APPC data formats.

21. The document and information control system of claim 19, wherein the plurality of transport mechanisms comprise file transfer protocol (IP/FTP), Net BIOS/Net BEUI printer shares, file sharing systems as established by network operating system manufacturers, line printer requestor/line printer daemon relationships (LPR/LPD), and Internet printing protocol.

22. The document and information control system of claim 18, wherein the plurality of input ports each maintains its own queue of unprocessed print jobs and a history of received print jobs.

23. The document and information control system of claim 18, wherein the plurality of output queues each include a transmission mechanism for examining and evaluating a status of the plurality of print devices.

24. The document and information control system of claim 23, wherein the transmission mechanism is selected from the group consisting of SNMP Query and Response, IP Ping and Response, Accessibility of Network File Share, and existence and content of a status file.

25. The document and information control system of claim 23, wherein the plurality of output queues generate an alert notification upon detection of an abnormal condition at its assigned print device.

26. The document and information control system of claim 25, wherein the alert notification is communicated to select alert recipients via an alert mechanism.

27. The document and information control system of claim 26, wherein the alert mechanism is selected from the group consisting of a network message, e-mail, visual on-screen alert, auditory alert, pager, voice mail, local application launch, remote application launch, and an error log entry.

28. The document and information control system of claim 17, further comprising an archive viewer storing all print jobs received at the system server.

29. The document and information control system of claim 28, wherein print jobs stored in the archive viewer are stored in the appropriate format of their destined print device.

30. The document and information control system of claim 17, wherein the generated print jobs include report data, and wherein the system server further comprises:
a forms database storing a plurality of different types of forms; and
a report formatting module (a) analyzing the report data, (b) selecting one of the plurality of forms from the forms database based upon the analyzation, and (c) merging the report data with the selected form to develop the received print jobs.

31. The document and information control system of claim 30, wherein the report data includes a first horizontal and vertical coordinate system and the selected form includes a second horizontal and vertical coordinate system, and wherein the system server further comprises a configuration file storing alteration information data indicative of merging report data having the first horizontal and vertical coordinate system with the form having the second horizontal and vertical coordinate system, the alteration information data accessed and used by the report formatting module in merging the report data with the selected form.
